(19) United States
(12) Patent Application Publication
(10) Pub. No.: US 2010/0005967 A1
(43) Pub. Date: Jan. 14, 2010

(54) METHOD TO SCRUB GREENHOUSE GASES FROM THE ATMOSPHERE

(75) Inventor: Dorothy M. Hartman, Philadelphia, PA (US)

Correspondence Address: DORTHY M. HARTMAN, 822 SO 5th Street, Philadelphia, PA, 19147, US

(73) Assignee: Dorothy M. Hartman, Philadelphia, PA (US)

(21) Appl. No.: 12/448,310

(22) PCT Filed: Mar. 19, 2007
(86) PCT No.: PCT/US2007/010293

§ 371 Date: Jun. 16, 2009

Related U.S. Application Data
(60) Provisional application No. 60/918,726, filed on Mar. 19, 2007.

(51) Int. Cl. B01D 53/14

(52) U.S. Cl. 95/232; 95/236; 95/235; 95/237

(57) ABSTRACT

Carbon dioxide, methane, nitrous oxide and three groups of fluorinated gases have been referred to as greenhouse gases and the most offensive gases in contributing to Global Warming This invention comprises the use of Titration and other chemical oxidation—reduction reactions in novel ways to scrub these gases from the Earth's atmosphere. The invention comprises identifying, developing, and spraying base aerosols to neutralize carbon dioxide, nitrous oxide, sulphur dioxide, and similar compounds whose oxides form acids when dissolved in water vapor. Acid-base titrations result in neutralization of the acid and the base. The formation of a salt and water typically are by-products. Salt precipitates such as CACO3—calcium carbonate or limestone settle into the oceans naturally forming limestone deposits which act as homes for microscopic sea life. Carbonic acid which results from CO2 being dissolved in water produces calcium carbonate when treated with a base. The invention proposes that by trials other natural salts may be identified which may safely be precipitated to the earth as it is important that the absorption into the Earth's environment occur with a minimum of deleterious effects. There exists a number of acids and The invention further comprises the novel use of vehicles such as space shuttles or a space station as delivery vehicles.

### BACKGROUND OF THE INVENTION

Carbon Dioxide, Methane, Nitrous Oxide, and three groups of fluorinated gases are referred to as greenhouse gases as they are causing a critical rise in the temperature of the earth's atmosphere contributing to a phenomenon known as Global Warming and creating climatic changes and changes in habitat for many of the earth's species. Most scientists accept that this is not a positive change and could mean catastrophic changes in the planet if some method(s) of eliminating or reducing these substances is not found.

The interest is in having the planet “go green” or adopt methods of conservation which protect from further pollution, encourage the replanting of trees and reducing dependency on and use of fossil fuels. Concern about the melting of the polar ice caps prematurely and discernable changes in weather patterns are making believers of some of the most skeptical regarding the effects of this gaseous pollution to the atmosphere.

To this extent there is now a conscious effort from countries participating in the Kyoto Protocol and even within the United States to come up with more environmentally friendly energy plans and to come up with methods to try and reduce the amount of emissions. Some of these methods include developing other forms of energy to satisfy the country's energy needs. Nuclear energy is one alternative which draws a mixed reaction. While nuclear power plants have served their purpose of providing a form of energy, at the same time nuclear power proposes its own risks and possibly disastrous consequences.

Wind power is another form of energy that is now being developed, but because the wind mills themselves dot the surface of the land and actually sometimes mar the beauty of landscapes and can present visual blocking—the number of windmills is by their nature of limited practicality. Solar energy is on the rise and does appear to be a suitable alternative of energy—harnessing the sun's natural ability to heat the earth.

fossil fuels like oil gas, and coal are the most abundant and most expedient sources of energy still. Since these fuels are also the most offensive in releasing these harmful gaseous emissions into the atmosphere—this becomes a perplexing and very critical problem to be solved in order to maintain a healthy life sustaining balance within the earth's biosphere. Therefore there is now a growing effort to find alternative fuels and methods to deal with these harmful gaseous emissions. This invention proposes innovative methods to deal with these issues.

Technology for solar energy which heretofore was very expensive is now becoming less expensive as nations such as China are starting to produce solar batteries at a more affordable price. Ethanol which is a derivative of corn products is also being used as a source of fuel. However the ethanol is being produced by growing huge crops of corn which in itself can be expensive as it is government subsidized and could result in other problems including soil depletion if crop rotation is not used effectively. There are arguments that the expense involved in producing ethanol offsets the benefits which may result from its use. Also because ethanol is an organic product—many believe that it does not substantially reduce the greenhouse effect.

Though currently the world still enjoys a semi glut in petroleum products and some coal still remains to be mined—most scientists agree that the sooner the earth can wean itself of petroleum based products and reduce its dependency on this fuel supply which in spite of alternative fuels still by far is being the most abundantly consumed by the world. With our constant demand for more and more automobiles—especially in developing countries like China, India, and now Africa—the use of fossil fuels has grown continuously with the increasing numbers—the earth may soon be at a point of no-return in getting back to a balanced atmosphere where Photosynthesis which releases oxygen and the Krebs Cycle which utilizes carbon dioxide can continue in their rhythm to keep the earth's atmosphere in a balanced condition.

We may have already reached a critical point. The deepest concerns and fears is that this use of fossil fuels may already be beyond what the earth can absorb. With billions of people and millions of automobiles. This invention proposes the use of oxidation—reduction chemical reactions in novel ways by employing the following method(s) for ridding the atmosphere of certain harmful gases, nitrous oxide, sulphur dioxide and among them, carbon dioxide which is causing the earth's atmosphere to rise by degrees creating the so-called greenhouse effect.

### FIELD OF THE INVENTION

This Invention, A Method to Scrub Greenhouse Gases From the Atmosphere, relates to using chemical methods, Acid-Base Titration and other Oxidation-Reduction reactions to change greenhouse gases such as carbon dioxide, sulphur dioxide and nitrous oxide into more beneficial forms. This will eliminate or reduce their presence in the atmosphere in an effort to reduce global warming and answer the question as to how to rid the earth of this preponderance of dangerous gases that have built up in the atmosphere as a result of the over consumption of fossil fuels.

The overuse of fossil fuels with no slow down in sight and no way to rid the earth of their by-products or dispense of the waste or redistribute the by-products in such a way as to rid the atmosphere of the consequences of this overuse are the reasons for this inventor's contribution of the following ideas. There is a desperate need to solve these problems. This invention is a part of the search for these solutions Though based on chemical laws and chemical theory, investigations of the method(s) must be applied as the method would involve applications to the earth's environment and therefore its effects upon the environment and living beings must be known and fully quantified in advance to determine its safety and feasibility.

The invention comprises a series of chemical methods or steps to (1) determine the best possible means of separating the known offensive compounds such as carbon dioxide, nitrous oxide, and certain other organic compounds from the air to develop a list of substances which can be used to neutralize or eliminate them (2) separation of the known chemicals (3) testing each chemical for its molality—number of moles per gram or the actual concentration of presence of the substance (4) testing each chemical for its molarity and determining what agents can be used to oxidize the chemical to achieve a less dangerous state, (5) carrying out the oxidation—reduction reactions for each chemical to titrate to a less dangerous state.

For example in reducing nitric acid to a less harmful state, the following equation would be utilized by adding drops of NaOh (the base, Sodium Hydroxide to Nitric Acid), the NAOH+H2(No)3>Na(No)3+H2O. The results being Sodium Nitrate which is a salt and water, both of which are less dangerous substances than either Nitric Acid or Sodium Hydroxide which are a powerful acid and a powerful base. The most challenging steps are to determine how to apply the bases or substances which have been identified as being able to work in neutralizing the dangerous agents to the environment in which the substances exist in their aggregate condition all together and not separated.

This invention, would result in aerosol spraying the earth's atmosphere—advisedly over the least populated areas of the planet in an effort to reduce risk to living populations “fall out” or possible damage to buildings. By doing the spraying from outer space—a larger area can be treated at any one time—and perhaps eliminate the need for repetition.

### ADVANTAGES OF THE INVENTION

Besides the obvious benefits derived from reducing this toxic buildup of these substances which are already demonstrating their negative effects through climate change and the changes in habitat and the extinction of natural species, there are other advantages. Because the method itself is a process to change the chemical nature of the greenhouse gases there would be no need to eliminate fossil fuel usage right away as it is not a likely scenario or even a practical option to ask the world to give up the use of fossil fuels completely. This is another decided advantage of this invention.

However it is increasingly becoming more abundantly clear that the use of fossil fuels must be seriously curtailed if the planet is to maintain its natural balance to sustain life and its chemical equilibrium. Though certainly the use of fossil fuels should be reduced and any methods to control carbon dioxide and other emissions such as the use of catalytic converters in vehicles continued as well as other means which are now being employed to control gaseous emissions—the ability to apply this invention without eliminating fossil fuel use altogether would be a critical advantage. This is a practical approach as giving up the use of fossil is not likely to be accepted by most peoples or nations, especially emerging nations. Lack of education and understanding, the romance with automobiles and fueled gadgets as well as the need for cooking and heat makes the cessation of fossil fuel usage in the near future improbable.

It is not likely that these harmful gases will ever be eliminated entirely due to a number of factors: a) the enormous scope of the problem; b) the lack of education and knowledge of the scope of the problem with many people throughout the developed and underdeveloped world; c) the constant and consistent use of fossil fuels likely to increase as countries like China and India with huge populations and growing economies purchase more automobiles and; d) new found wealth in developing countries such as Africa, Central and South America, the Pacific rim and other areas of the world and the demand for more fossil fuels; e) the possible restrictions of available resources needed to fight back—even sufficient quantities of resources such as basic aerosol sprays must be developed to neutralize the enormous amounts greenhouse gases; f) even if the oxide compounds can be removed other compounds such as methane, CFC-12, HCFC-22, Tetraflouromethane and Sulphurhexaflouride which are complex and less chemically active or inert are exceedingly hard to eradicate and may remain. However, even if this new and useful invention only reduces the amount of harmful substances in the earth's atmosphere it may be enough to stave off or slow down some environmental changes like the continued melting of polar caps, the rising of the oceans, and the dramatic climactic changes which are already occurring and by every indication at an accelerating rate.

### BRIEF DESCRIPTION OF THE SEVERAL VIEWS OF THE DRAWINGS

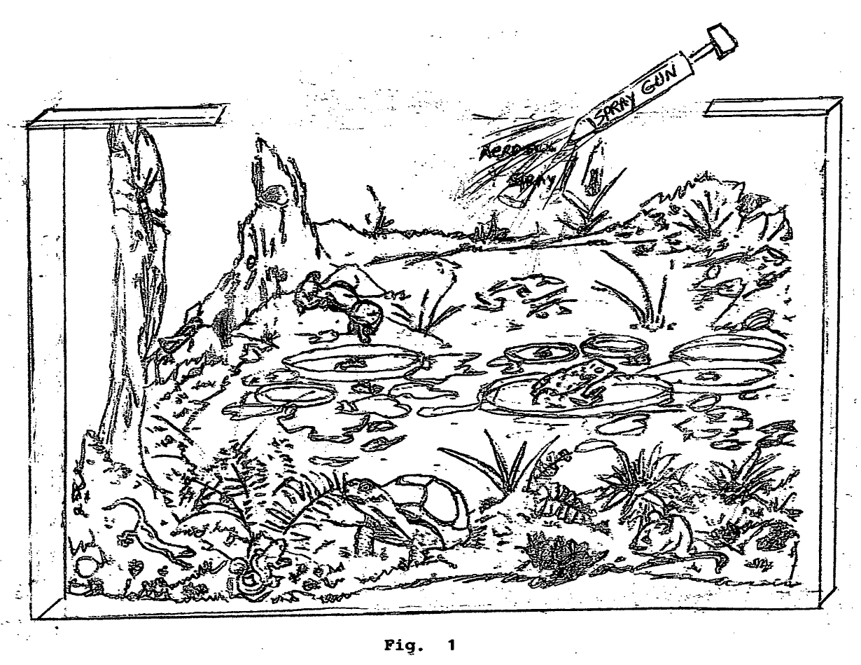

This invention comprises method(s) with a number of steps, some of which have already been identified to categorize and describe the invention. Other steps are identifiable only upon examination and experimentation. To achieve this, certain experiments would have to be set up using experimental and control terrarium chambers or biospheres enclosing representative plants and animals and even inanimate objects such as rocks and as shown in FIG. 1. It shows plant and animal life enclosed in a terrarium, or biosphere for the purpose of testing the effects of the sprays and chemical reactions on living and non living things to determine what chemicals can be applied with a minimum of risk to achieve the desired results. This is testing within a controlled and limited environment. This research would determine the resultant products that might achieve the neutralization sought and converting those product(s) into safe aerosol sprays before the method(s) is applied in a natural environment.

The standards of what is considered safe to be determined as if there are negative effects—but a preponderance of positive effects over those negative effects and successful administering of the product may deem the spray as “safe”. It is unlikely that by-products will not result. Therefore in addition to chemical trials, these closed ecosystems to determine the effects of each chemical are critical and must be used in developing the aerosol sprays of bases or other substances which are identified from the trials as possibly working to eliminate the offensive substances or at least change them into a form which will be less harmful to the environment. The trials of spraying the aerosol into these closed ecosystems will give valuable information as to how the aerosol works and how we can protect living and non living things.

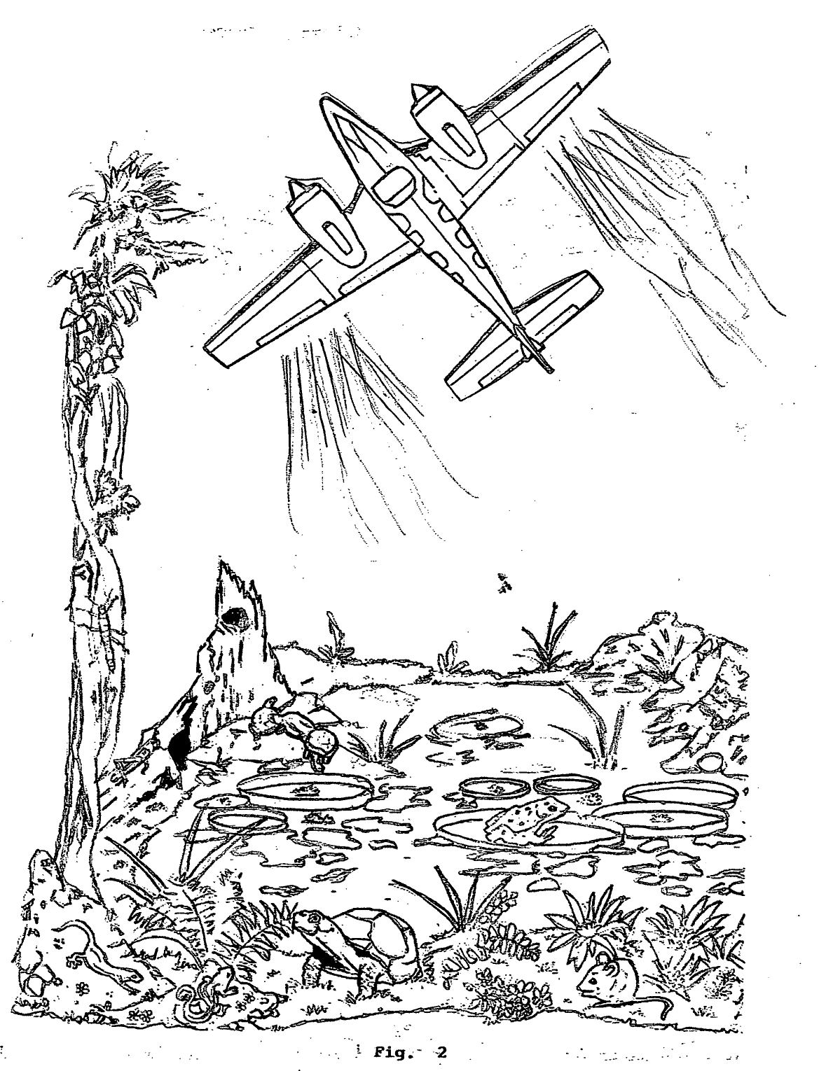

If the aerosol spray works within the ecosystem in the laboratory and its effects are known and both quantified—and qualified as long as these effects are predominantly positive—then the aerosol spraying would be applied as illustrated in FIG. 2, which is test spraying in a small but open area of the earth within low altitude such as a plane flying over a field. This is a larger area than that in FIG. 1 but still small enough to exercise more control over the results. This will give even more information about the actions of the aerosol agent and whether or not the results of reducing carbon dioxide emissions and methane which are the most offensive has been achieved and what clean up efforts, if any may be needed.

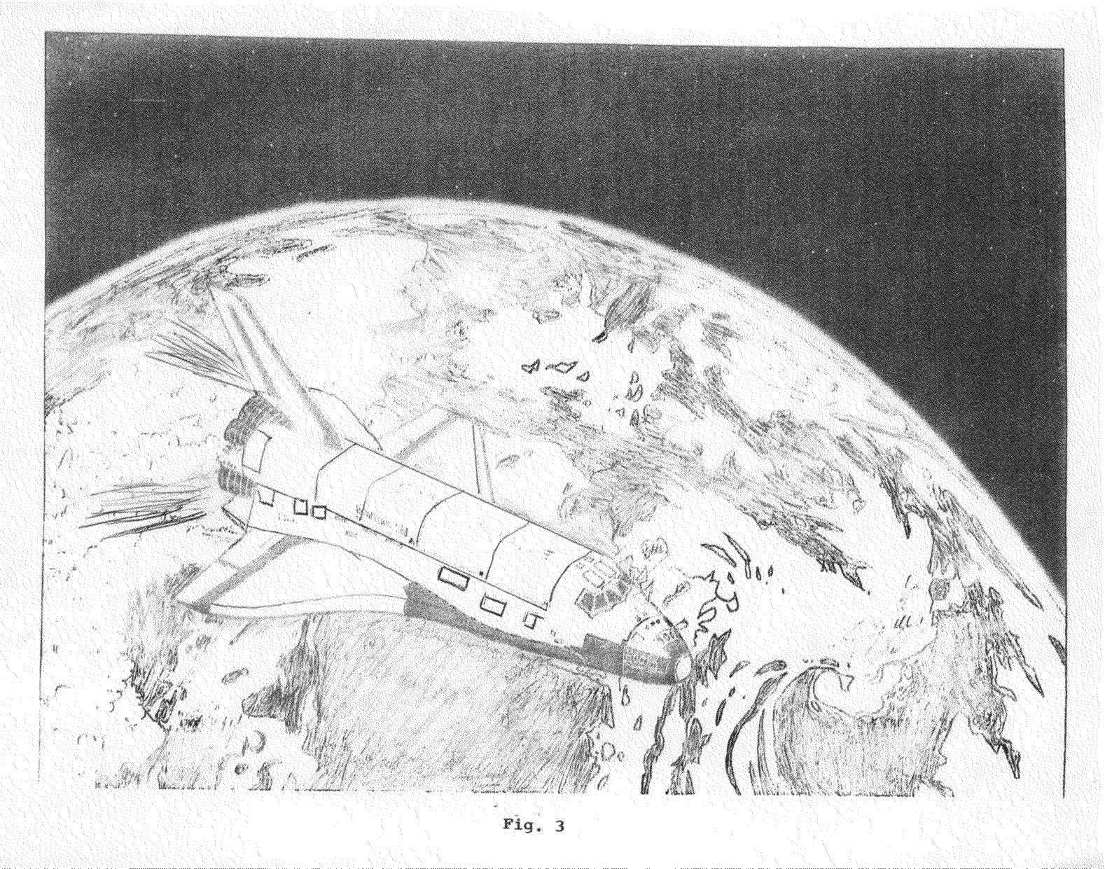

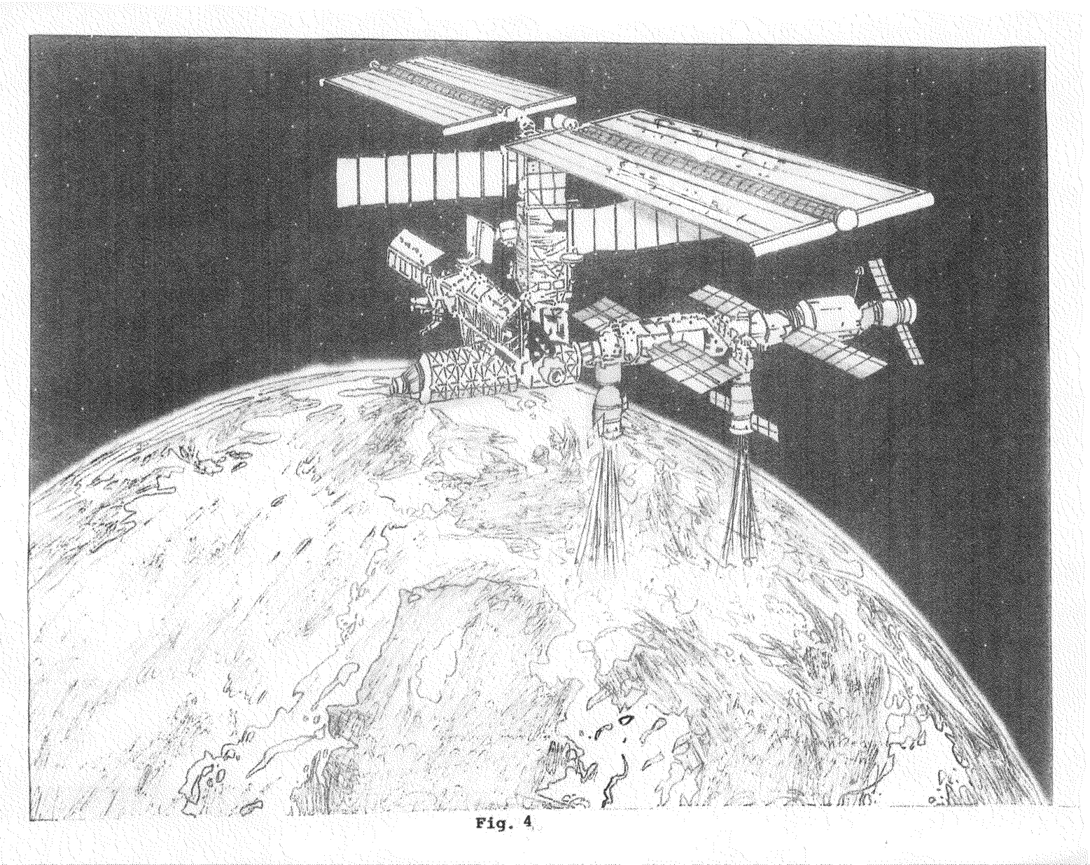

If this can be done with a preponderance of positive effects, and clean up methods or assimilation of the by-products into the environment achieved, then the final step would be to apply the aerosol(s) to the environment of the planet. The most effective way of doing this is outlined in the drawings FIG. 3 and FIG. 4. These figures represent proposed possible methods of delivering the aerosol. Special high flying planes or space vehicles would be necessary to deliver the spray in significant quantity and large areas. FIG. 4 shows aerosol being delivered via a jet spray or some type of high powered delivery system from the Space Station to Earth's atmosphere. FIG. 3 also shows a hypothetical and proposed method of delivering the aerosol spray by the Space Shuttle. Both of these figures shown are hypothetical because a delivery system for either the Space Shuttle or the Space Station would have to be engineered by NASA or some other similar type agency applying their own protocol, rules and regulations as such engineering and administration is beyond the scope of this invention. However within the scope of the invention is consultation with others to develop a spray delivery system once base sprays have been identified and aerosols created.

Only specialized space vehicles like the ones described or ones built for this purpose of tremendous speed and scope could be used to deliver the aerosol in sufficient quantities in order to achieve the desired results of spraying effectively extremely large areas of the planet. Both these structures, the Space station or the Space Shuttle are the only vehicles now existent which have the size and capacity and are at a far enough distance from the planet to focus and concentrate on specific target areas of the planet. Only these structures or structures comparable to them being deep in outer space and above the earth's atmosphere, having size and capacity with a system built and modified just for that purpose would be in a position to deliver the aerosol in meaningful amounts and to the earth's atmosphere to achieve the desirable results. The desirable results being to titrate the concentrations of acidic gases with equivalent concentrations of aerosol bases to the point of neutralization which would be the formation of a salt and water. This would be necessary to significantly reduce the offensive greenhouse gases which exist in phenomenal amounts within the earth as the earth is a planet which is about 25,000 miles in circumference and its atmosphere is hundreds of miles thick.

### DETAILED DESCRIPTION OF THE INVENTION

This invention uses Titration and Neutralization and other forms of chemical Oxidation-Reduction reactions as possible means by which to rid the environment of certain harmful gases which are contributing to the “Greenhouse Effect” on the planet and consequently contributing to the phenomenon of Global Warming. Establishing the methodology is achieved by the following objectives: (1) developing a series of separation techniques would be used to first separate the components of a sample of the naturally occurring atmosphere; determine the concentrations of the offending compounds; determine what compounds and in what amounts they are needed exactly to work against the offensive substances; to devise methods as to how the compounds will work in aggregate form (as part of the atmosphere dissolved among other gases),

(2) Identifying and developing aerosols of base sprays or other compounds that can be used to titrate these greenhouse gases, many of whom form acids when dissolved in water vapor within the atmosphere (3) developing and testing methods in which the spraying could be safely expedited by using a contained environment such as a biochamber in a laboratory in studying the effects of spraying these aerosols upon living organisms and nonliving things within the environment. (4) developing or consulting with engineers or others towards the development of a spraying device that can be mounted on a vehicle such as a space shuttle or space station for the purpose of delivery of the aerosol spray to portions of the earth's atmosphere (5) study of prevailing wind patterns or consultation with meteorologists and oceanographers to develop safest and most opportune times to do spraying so as to allow for a large part of the salt particulate matter to precipitate into the oceans and (6) devising methods of clean-up and disposal of waste salts or other by-products which may result from the chemical spraying.

Such experimentation to first be carried out within a controlled and contained environment for reasons previously stated and later in a larger less contained environment after determining safety and feasibility of method(s). The method(s) to be used on the following substances which have been identified as the most abundant and the most prolific causes of global warming: Carbon Dioxide, Methane, Nitrous Oxide and 3 groups of florinated gases. These have been the subject of the Kyoto Protocol—an international conference of certain nations of the world seeking solutions as to what to do about the so called “greenhouse effect” of these gases on our planet.

Desired results being the reduction or elimination of these harmful substances—removal and cleanup or the resolution of less harmful by-products into the environment (those which can be assimilated into the earth's environment with minimum damage)

Chemical Methods to be employed are those which have been previously listed or are listed below. Other steps or methods including but not limited to chemical to be determined by experimentation and testing within the scope of the invention:
A. Determine Molality—determine concentrations of green house gases Determine greenhouse gases, their percentages by obtaining and samples of air for environmental studies

$$Mole fraction of Component 1 = \frac{n 1}{n 1 + n 2 + n 3}$$

Mole fraction of Compound=moles of compound/total unity of other compounds

Total Unity of other compounds=moles of compound 1(×1)+moles of compound 2(×2)+moles of compound 3(×3)

Sum of all mole fractions ×1+×2+×3+ . . . =1

B. Determine Molarity of those critical compounds: CO2, SO2, NO—carbon dioxide, sulphur dioxide, and nitrous oxide. Determine in closed, controlled chamber whether the use of titration and neutralization could be used to effect these chemicals only and not interact with the other chemicals. Determine nature of interaction, if any with other air components and devise methods of dealing with same. Also determine other methods of separating these substances from each other and also from the chlorofluorocarbons.
C. (1) determine number of moles of CO2 (2) determine concentration of carbonic acid (3) determine what would be the safest bases to used determine number of moles of NO and SO2 (4) Study and determine what bases can most effectively be used. Do a series of steps using different bases to determine which are best and what salts can most safely be used in the environment. All effort should be made to obtain salts that can be resolved within the environment as clean up efforts may themselves be harmful or just too expensive.
D. Determine what bases can most readily and less caustically be used to titrate these compounds from the air sample. Determine molarity of these bases such as naoh, ca(oh)2. The molarity of a solution is the number of moles of solute in 1 liter of solution. However, since the volume of the solution depends on temperature, the concentration expresses in units of molarity also depends on temperature. This is a disadvantage Acid-Base Titration is one of the methods to be used in this method. The general procedure is to determine the amount of, let's say an acid by adding an equivalent measured amount of a base or vice-versa. The neutralization point is the point at which enough of the base has been added to chemically change the acid so that it is no longer available. It has instead become a salt and water. If you know the concentration of your acid, you can determine the concentration of the base needed to accomplish the neutralization by employing techniques and formulae such as the ones below. In order to see how to design a good acid-base titration experiment, it is useful to calculate the concentration of H30+ at various stage in the titration of 50.00 ml of 1.OOOM HCL with 50.00 ml of 1.OOOM NaoH. We will give the value of f, the fraction of the original acid that has been neutralized. If the original number of moles of HCL is denoted by NO, f is given by f=number of moles of base added/NO
At the start of the titration f=0, and fM corresponds to a completely titrated acid, or the equivalence point of the titration. Before the titration starts, H3O+=1 M, and ph=0. To calculate H3O+ for O<f<1, we let V=original volume of the acid v=volume of the base added
Then, since both acid and base have the same concentration, f=v/V m and the amount of acid at any stage in the titration is H3O+=nO (1−f)=nO (1−v/V)
To obtain the concentration of H3O+, we divide by the total volume of the solution

$$H 3 O += \frac{no ( 1 - v / V )}{( V + v )} = \frac{no ( 1 - f )}{( V + v )}$$

E. Another way of looking at Titration is from the perspective of ph. Water or H2O Is considered neutral or to have a ph of 7. Acids are at the low end of the ph scale, 1-6 with the strongest and most caustic acids being the lowest ph, for example an acid with a ph of 3 would be a strong acid. However an acid with a ph of 1 would be stronger still. Bases are at the high end of the ph scale, 8-14. Conversely a base with a ph of 12 would be a strong base, and a base with a ph of 14 would be stronger still. By applying titration techniques, we determine what bases are necessary to neutralize what acids and in what concentration. Since it really is the amounts that matter as we know that any base may conceivably neutralize any acid, what is important is determining the concentrations by trial and calculations.
F. Also devise method of trying to study wind patterns in contrived laboratory set up in anticipation that meteorologists charts and predictions would be used to determine what times are safest for spraying. Prevailing winds will carry the fall out as quickly as possible over the ocean so as to encourage precipitates and particulate matter to fall into the oceans. Precipitates such as CACO3—calcium carbonate or limestone settle into the oceans naturally forming limestone deposits. These limestone deposits can actually produce natural barrier reefs and other sediments that in time create homes for ocean fauna and flora (microscopic and tiny plants and animals which form the basis of the food chain for marine life). There may be other salts which can be absorbed into the earth's biosphere without creating too much havoc to man and nature. The nature and safety of these particulates to be determined in the containment laboratory and through experimentation. KOH, Mg(OH)2, NAOH, NH4OH are really powerful bases, but there are less dangerous bases.

$$F = \frac{Number of Moles of Base}{Number of moles of Acid}$$

Titration may be used in this innovative method for the scrubbing greenhouse gases such as carbon dioxide, sulphur dioxide and nitrous oxide as these form acids when their oxides are dissolved in water vapor as they would be in the atmosphere. The challenge is in finding “safe” bases potent enough to do the job but benign enough to be distributed in a “safe” manner. These bases would then be produced as aerosol sprays to be used to “seed” the clouds or the atmosphere to attempt to “scrub” the concentrations that have been detected and determined by calculations. Afterwards methods having been determined by testing will be used to deal with the “fall out” to the earth or preferably to the oceans of the particulate matter from the formation of salts. Calcium Carbonate or limestone which is a naturally occurring salt, is present in large formations and generally benign to the Earth is a desirable precipitate—although other salts may be formed depending upon the type of base used.

NaOH, Sodium Hydroxide can be used to neutralize carbonic acid but NaOH hydroxide is a powerful and caustic base and therefore would not be a good compound to use. Calcium Oxide is less caustic but a series of steps would determine what are the least caustic bases and the weakest concentrations that could be used to achieve the desired results: CaO(s) Calcium Oxide+Co2 (g) carbon dioxide-->Ca Co3 Calcium Carbonate Limestone is relatively benign and is found in abundance in the environment. Carbon dioxide, if present as HCO3+ carbonic acid can be titrated. Oxidation-reduction reactions may be necessary to convert CO2 and NO to carbon dioxide and nitrous oxide to carbonic acid or nitric acid so that they may be titrated if they are available in the gaseous state and not dissolved in water vapor. Generally both carbon dioxide and nitrous oxide will form acids when dissolved in water: CO3+H2O=HCO3+OH—

This is one of a possible series of chemical reactions in what would be a numerous number of different types of oxidation reduction reactions employed to determine exactly what chemicals could be safely and effectively used to convert what essentially is a monumental amount of atmospheric pollution into a benign form. Research is essential to determine exact chemicals and exact steps required to actually accomplish the desired results as this invention proposes steps or methods utilizing chemical theory and laws in these innovative ways to help solve what has become a monumental environmental problem.

If successful aerosol sprays can be identified and created, and a successful system engineered to deliver them using these new and innovative method(s) of using established chemical laws, then this invention may be useful in helping to solve what has become an overwhelming problem facing the earth and possibly causing its extinction. If successful aerosols are created, spraying should probably be applied to the least populated areas of the planet as some negative effects are probable—those yet to be identified. Because of the enormous amount of aerosol spray needed and accepting the realization that it is highly improbable that greenhouse gases will be eliminated altogether, careful consideration should be given to those areas of the atmosphere that should be treated. The poles of the earth or areas close to the poles should probably be treated first. Primarily, to end the melting of ice caps which is happening at an alarming rate. Also to reduce causing less trauma to living beings which though populated in Arctic and Antarctica are more populated in warmer, more hospitable climates.

Also we do not yet know the effect of the spray foam on buildings and construction. This is why testing is so important and meteorologists, oceanographers, and geologists should be consulted to try to determine opportune times and optimum areas for spraying so as to achieve the best possible results. negative effects, if any should result, ironically may be less deleterious than the continued buildup of these pollutant substances. Also we can control how much to spray and how often. To continue to allow these greenhouse gases to increase unchecked knowing the harm caused by Global Warming without applying our most creative and strenuous efforts towards cleaning them up is not an option.

1. This invention proposes the use of oxidation-reduction chemistry including but not limited to acid-base titrations to scrub greenhouse gases such as carbon dioxide, nitrous oxide, and sulphur dioxide from the atmosphere, carbon dioxide being one of the most prolific offenders.

2. This invention proposes using chemical formulas and laws for the purpose of identifying compounds including bases which can be used in the innovative method of being converted to an aerosol solution that can be used to titrate acids which results from carbon dioxide and other greenhouse gases dissolving in water vapor in the atmosphere. Acid base titration can be useful as most of these oxides form acids when dissolved in water and water vapor fills the air. carbon dioxide and other carbon compounds not only increase the temperature of the air, but nitric acid and sulphuric acid are caustic substances that create acid rain which is both toxic and corrosive. This invention proposes using established chemical laws in new ways to help solve our environmental problems.

3. This invention proposes the following innovative STEP research in identifying substances, especially bases which may be deemed safe as acid and bases by their nature are caustic substances, with some more caustic than others. The first steps to be carried out in a closed controlled environment, a laboratory or biosphere. See FIG. 1 where a terrarium with a pond populated with such organisms as small rodents, turtles, frogs, ferns, water lilies are contained. Sprays which are developed can be administered by using a manual saying gun so that quantities and the effects of those quantities can be measured easily. Small amounts of the spy can be released at a time to gauge the effect of the spray on both living and non living things. Measure resulting precipitate. Also spraying is restricted to the laboratory or the biosphere as a precaution, FIG. 1

4. This invention comprises Step—Processes of methodically testing and analyzing atmospheric samples to determine the concentrations of the offensive compounds such as the aforementioned so called greenhouse gases because of their propensity for heating up the atmosphere. To know how much spray would be needed it is necessary to calculate to the closest extent possible the amounts or concentrations of these gases in the atmospheric samples.

5. The method(s) involve but are not limited to a number of sub steps, calculations, and procedures to be employed: a) Use of Molality such as the number of moles of solute dissolved in a solvent and Normality to determine concentrations of substances; b) to use known and create separation methods for isolating target gases as methods must be determined which will show the effects of spraying in both scenarios when compounds are separated and when they are in an aggregate condition—which is how they occur normally mixed in with other gases and substances;
c) Use of Molarity such as the number of moles of solute in 1 liter of solution for Titration techniques; d) determination of specific bases and the specific concentration required to react with a specific concentration of acid to produce neutralization needed for neutralization; e) Conversion of base to base solution and aerosol or spray foam All of which are to be used in the new and useful method of preparing base sprays that can be delivered in innovative ways by space vehicles to the Earth's atmosphere in an effort to scrub greenhouse gases and significantly reduce global warming.

6. This invention proposes the use of aerosol sprayers, crop dusters or other special spraying planes FIG. 2, and the novel use of vehicles such as space shuttles FIG. 3, or space station to FIG. 4 spray aerosol into designated areas on the Earth's atmosphere. Spraying from space will enable spraying over larger areas. Also will make targeting specific areas easier—enabling spraying in less populated areas. Inventor states this invention can be used with or without a decrease in the use of fossil fuels, though a decrease in the use of fossil fuels would be desirable. A less build up of emissions from fossil fuels would lead to better results as perhaps the spraying would not have to be repeated as it is unlikely that no negative effects or by-products would result. However these negative effects may be a suitable alternative to allowing greenhouse gas emissions to increase unabated resulting in what we know are deleterious effects—especially if there is a preponderance of positive results with using this inventive method(s).

7. After determining by calculation and trials, this invention proposes the innovative method of producing aerosols from aqueous solutions of the identified bases for the purpose of titrating acidic solutions of pollutant compounds such as carbon dioxide, nitric oxide, and sulphur dioxide from the atmosphere by neutralizing them into by products of salt and water.

8. The innovative method of incorporating the materials and methods learned in claims 2-5 and methodically testing the results in a field or open area, a semi-controlled environment FIG. 2. The amount of control proportional only to amount of spray and the size of the field as it is impossible to contain the spray in open air as the particles will diffuse. However once safety guidelines have been established in a closed environment, FIG. 2—the step of spraying into an open area is a critical one in determining the readiness to move towards spraying the planet. More observations can be done in an open field of effects on wildlife, plants and streams and inanimate objects such as rocks. The effect of the spray on rocks can give some indication as to how the spray or particulate matter from salts would effect construction and buildings as it is improbable that all of the spraying would escape cities or populated areas.

9. invention comprises the innovation that once it has been determined which base or bases may be applied in this novel manner as testing may show that more than one base may prove feasible—methods by trial and error which devise means in which mass quantities of the identified bases can be acquired or produced.

10. This invention comprises new uses for established chemical principles by using oxidation-reduction reactions, most notably titration to scrub large concentrations of carbon dioxide, nitric oxide, and sulphur dioxide which are among the greenhouse gases overheating the Earth's atmosphere. This new and useful design can be used without the elimination of fossil fuels, which is difficult, if not impossible since the world is so dependent on these fuels. The continued use of conservation methods to try to reduce the amount of pollutants as well as a search for alternate fuels must continue. The inventor proposes that a successful use of this invention along with other efforts may considerably reduce the greenhouse effect—giving us time to re-forest our planet and develop alternate fuels.
